(19) United States
(12) Patent Application Publication
(10) Pub. No.: US 2009/0236194 A1
(43) Pub. Date: Sep. 24, 2009

(54) VALVE APPARATUS OF SHOCK ABSORBER

(75) Inventor: Hong Sig Kim, Iksan-si (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Pyeongtaek-si (KR)

(21) Appl. No.: 12/408,591

(22) Filed: Mar. 20, 2009

(30) Foreign Application Priority Data
Mar. 20, 2008 (KR) 10-2008-0025790

(51) Int. Cl. F16F 9/34

(52) U.S. Cl. 188/322.15

(57) ABSTRACT

A valve apparatus for a shock absorber includes a piston valve having rebound and compression passages, a sliding valve movably coupled to a piston rod to block and open the rebound passages, and at least one valve disc provided at a lower side of the sliding valve and separated a predetermined distance from a washer by a retainer. The valve disc can be bent while resiliently supporting an outer periphery of the sliding valve. The valve disc has an increased size, so that easy control of a damping force at low speed and a gradual increase of the damping force even at high speed can be obtained by the shock absorber having a decreased size.

### BACKGROUND

1. Technical Field

The present disclosure relates to a valve apparatus mounted to a shock absorber to generate a damping force and, more particularly, to a valve apparatus of a shock absorber that improves an installation structure of discs on a piston provided to generate a damping force.

2. Description of the Related Art

In general, a vehicle is provided with a suspension system for enhancing driving comfort by buffering impact or vibration transmitted from a road to an axle during driving. One component constituting the suspension system is a shock absorber. The shock absorber is disposed between the axle and a vehicle body, and includes a cylinder and a piston rod reciprocating in the cylinder. The cylinder is filled with an operating fluid such as gas or oil, which is moved by a piston valve secured to one end of the piston rod to generate a damping force.

FIG. 1 is a cross-sectional view of a valve apparatus of a conventional shock absorber. Referring to FIG. 1, the shock absorber 10 includes a cylinder 12 connected to a wheel side, and a piston rod 14 with one end thereof movably disposed in the cylinder 12 and the other end connected to a vehicle body.

The piston rod 14 is provided at one end thereof with a valve apparatus 20 which controls a damping force between a compression chamber CC and a rebound chamber RC in the cylinder 12.

The valve apparatus 20 includes a piston valve 22 provided toward the end of the piston rod 14 to divide an interior space of the cylinder 12 into the compression chamber CC and the rebound chamber RC. The piston valve 22 is formed with rebound passages 22a and compression passages 22b through which a fluid can flow between the compression chamber CC and the rebound chamber RC.

Further, an intake valve disc 23 for opening the compression passages 22a during a compression stroke, a retainer 24, an intake spring 25, and an upper washer 26 are sequentially stacked on the piston valve 22. Further, a valve disc 27 is provided toward a lower side of the piston valve 22 to generate different damping forces by controlling an opening degree of the rebound passages 22b in low and high speed areas. Under the valve disc 27, a retainer 28, a lower washer 29, and a nut 30 securing these components are provided in this order. Here, the number of valve discs 27 may be at least one. When plural valve discs 27 are provided for variation of damping force characteristics, the valve discs may have different shapes or some of the valve discs may be formed with slits.

In the valve apparatus 20 of the conventional shock absorber 10, the valve disc 27 must have a large outer diameter in order to allow the damping force characteristics to be gradually generated at high speed. However, there is restriction in increasing the outer diameter of the valve disc 27 due to restriction in size of the piston valve 22. Moreover, since the size of the piston valve 22 is decreased according to a recent trend of decreasing the size of the shock absorber 10, it is necessary to decrease the outer diameter of the valve disc 27 which controls the opening degree of the rebound passages 22b. However, when decreasing the outer diameter of the valve disc 27, there is a problem in that the damping force characteristics cannot be easily controlled at low speeds.

### BRIEF SUMMARY

The present disclosure is directed to solve the problems of the related art as described above, and one embodiment includes providing a valve apparatus of a shock absorber, in which a valve disc controlling an opening degree of rebound passages has an increased size to permit easy control of a damping force at various speeds, including low speeds, and a gradual increase of the damping force even at high speed while enabling a size decrease of the shock absorber.

In accordance with one aspect, a valve apparatus of a shock absorber is provided to a piston rod of the shock absorber and generates a damping force by controlling a fluid flow between a rebound chamber and a compression chamber. The valve apparatus includes a piston valve having rebound passages and compression passages allowing a fluid flow between the rebound chamber and the compression chamber, a sliding valve movably coupled to the piston rod under the piston valve configured to block and open the rebound passages, and at least one valve disc provided at a lower side of the sliding valve and separated a predetermined distance from a washer by a retainer, the washer being coupled to a lower side of the retainer, the valve disc being capable of bending while resiliently supporting an outer periphery of the sliding valve.

The sliding valve may be formed toward an upper side thereof with at least one slit allowing the fluid flow between the rebound passages and the compression chamber. The valve apparatus may further include a slit disc disposed on the upper side of the sliding valve and having a slit formed on a circumference of the slit disc to allow the fluid flow between the rebound passages and the compression chamber. Further, a lower side of the sliding valve may extend outside the piston valve and may be formed at an end thereof with a stepped portion having a gradually increasing outer diameter. The valve apparatus may further include a guide bush interposed between the sliding valve and the piston rod to guide upward and downward movement of the sliding valve.

### BRIEF DESCRIPTION OF THE SEVERAL VIEWS OF THE DRAWINGS

The above and other aspects, features, and advantages of the present invention will become apparent from the following description of exemplary embodiments given in conjunction with the accompanying drawings, in which:

FIG. 1 is a cross-sectional view of a valve apparatus of a conventional shock absorber;

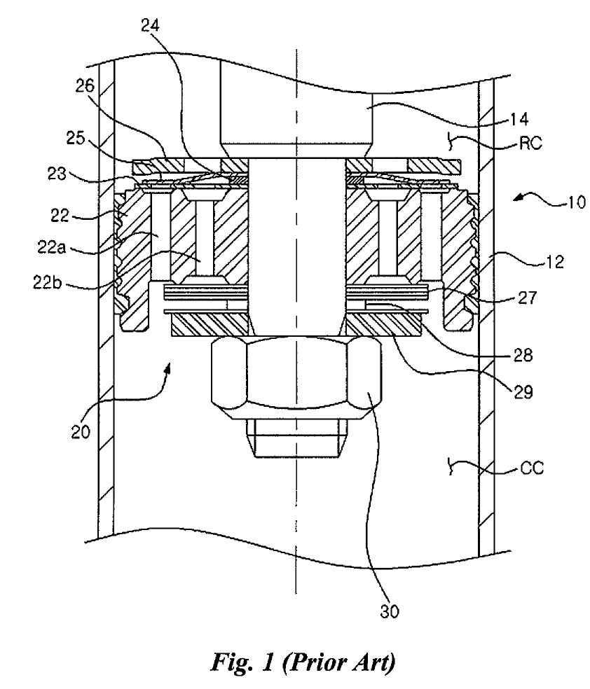

FIG. 2 is a partial cross-sectional view of a shock absorber according to one embodiment;

FIG. 3 is a cross-sectional view of a valve apparatus of a shock absorber according to one embodiment;

FIG. 4 is a cross-sectional view of the valve apparatus of the shock absorber during low speed driving according to one embodiment;

FIG. 5 is a cross-sectional view of the valve apparatus of the shock absorber during high speed driving according to one embodiment;

FIG. 6 is a cross-sectional view of a valve apparatus of a shock absorber according to another embodiment; and

FIG. 7 is a cross-sectional view of a valve apparatus of a shock absorber according to a further embodiment.

### DETAILED DESCRIPTION

Exemplary embodiments, namely examples of embodiments, will now be described in detail with reference to the accompanying drawings.

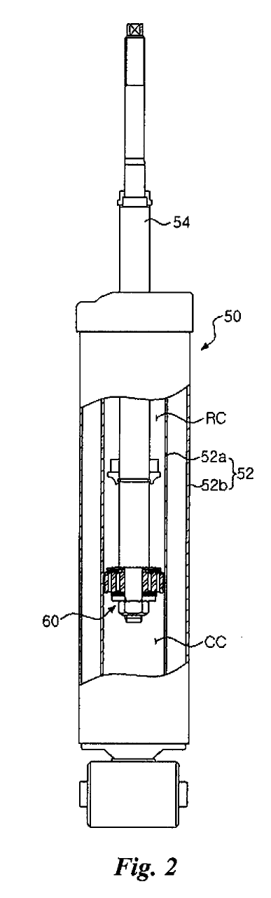

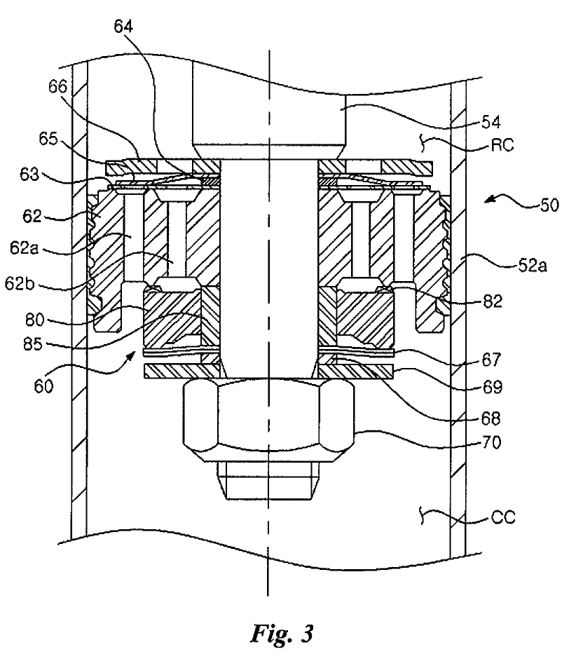

FIG. 2 is a cross-sectional view of a shock absorber according to one embodiment of the present invention, and FIG. 3 is a cross-sectional view of a valve apparatus of a shock absorber according to one embodiment of the present invention.

In FIGS. 2 and 3, a shock absorber 50 according to one embodiment includes a cylinder 52 connected to a wheel side of the vehicle, and a piston rod 54 connected to a vehicle body side. The cylinder 52 may have a double-tube structure comprising an inner tube 52a and an outer tube 52b, or it may have a single-tube structure in another embodiment.

The piston rod 54 is disposed in the cylinder 52 to reciprocate therein, and includes a valve apparatus 60 which is coupled toward one end of the piston rod 54 and divides the interior of the cylinder 52 into a compression chamber CC and a rebound chamber RC.

Referring to FIG. 3, the valve apparatus 60 includes a piston valve 62 which has a through-hole formed at the center thereof such that the center of the piston valve 62 can be coupled to the piston rod 54. The piston valve 62 has compression passages 62a formed apart from the center of the piston valve 62 and rebound passages 62b formed between the center of the piston valve 62 and the respective compression passages 62a. The compression and rebound passages 62a and 62b are formed to allow a fluid flow between the compression chamber CC and the rebound chamber RC during compression and rebound strokes for lowering and raising the piston rod 54.

Further, an intake valve disc 63, a retainer 64, an intake spring 65, and an upper washer 66 are stacked on an upper side of the piston valve 62. The intake valve disc 63 can be bent to rapidly open the compression passages 62a during the compression stroke of the piston valve 62. Further, the piston valve 62 is provided at a lower side thereof with a valve structure for rebound to generate a damping force during the rebound stroke.

The valve structure for rebound will be described in more detail hereinafter. The valve apparatus 60 includes a sliding valve 80 disposed toward a lower side of the piston valve 62 configured to block and open the rebound passages 62b. The sliding valve 80 is coupled to the piston rod 54 to reciprocate along the piston rod 54.

Further, a valve disc 67 is provided under the sliding valve 80 and can be bent while resiliently supporting an outer periphery of the sliding valve 80. In some embodiments, the valve apparatus 60 may include one or more valve discs 67, which may have different sizes and shapes according to a resilient supporting force of the sliding valve 80.

The valve apparatus 60 may further include a guide bush 85 interposed between the sliding valve 80 and the piston rod 54. The guide bush 85 enables more smooth upward and downward movement of the sliding valve 80 on the piston rod 54 and provides a space for movement of the sliding valve 80. Further, the guide bush 85 contacts an upper side of the valve disc 67 to restrict upward movement of the valve disc 67, thereby enabling more accurate control of damping force.

The piston valve 62 is provided toward the upper and lower sides thereof with valve sheets to divide the compression passages 62a and the rebound passages 62b and to support the valve disc 67, respectively. The sliding valve 80 has a protrusion which contacts the valve sheet.

Further, the sliding valve 80 is formed at an upper side thereof with a slit 82 which permits a fluid flow between the rebound passages 62b and the compression chamber CC. The slit 82 may be formed in the protrusion of the sliding valve 80.

The slit 82 of the sliding valve 80 allows a fluid passing through the rebound chamber 62b to flow into the compression chamber CC, and, particularly, affects generation of the damping force in low speeds.

A retainer 68 is disposed under the valve disc 67 and maintains a predetermined distance between the valve disc 67 and a lower washer 69 located under the retainer 68. The lower washer 69 restricts a bending degree of the valve disc 67. Further, the retainer 68 provides a bending space for the valve disc 67. The valve apparatus 60 is secured by a nut 70, which is coupled to a lower side of the piston rod 54.

Next, operation of the valve apparatus of the shock absorber according to one embodiment will be described.

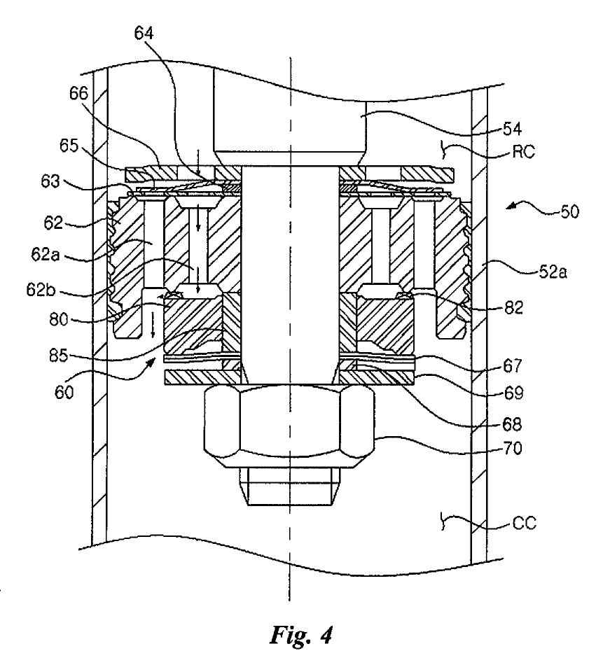

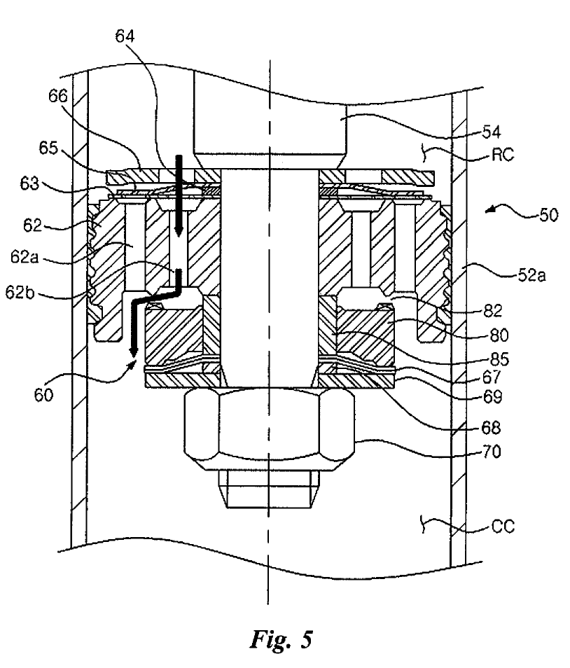

FIG. 4 is a cross-sectional view of the valve apparatus 60 of the shock absorber 50 during low speed driving according to one embodiment, and FIG. 5 is a cross-sectional view of the valve apparatus 60 of the shock absorber 50 during high speed driving according to one embodiment.

Referring to FIG. 4, when the piston valve 62 in the valve apparatus 60 of the shock absorber 50 moves at low speeds during a rebound stroke, a fluid passes through the rebound passages 62b and is discharged into the compression chamber CC through the slit 82 of the sliding valve 80. At this time, while passing though the slit 82, the fluid undergoes fluid resistance, which generates a damping force when the vehicle travels at low speeds.

Referring to FIG. 5, when a rebound speed of the shock absorber 50 is increased or pressure is increased thereby, the damping force generated by the valve apparatus 60 of the shock absorber 50 increases. At this time, the amount of fluid passing through the rebound passages 62b increases to cause a greater amount of fluid than the amount of fluid passing through the slit 82 to pass through the rebound passages 62b. Then, the fluid compresses the sliding valve 80 to bend the valve disc 67 which resiliently supports the sliding valve 80, thereby generating a damping force when driving at high speed.

As such, the valve apparatus 60 of the shock absorber 50 according to one embodiment has been described with reference to the drawings, but it should be noted that the present invention is not limited to the embodiment and various modification and changes can be made by a person having ordinary knowledge in the art without departing from the scope and spirit of the present invention defined by the accompanying claims.

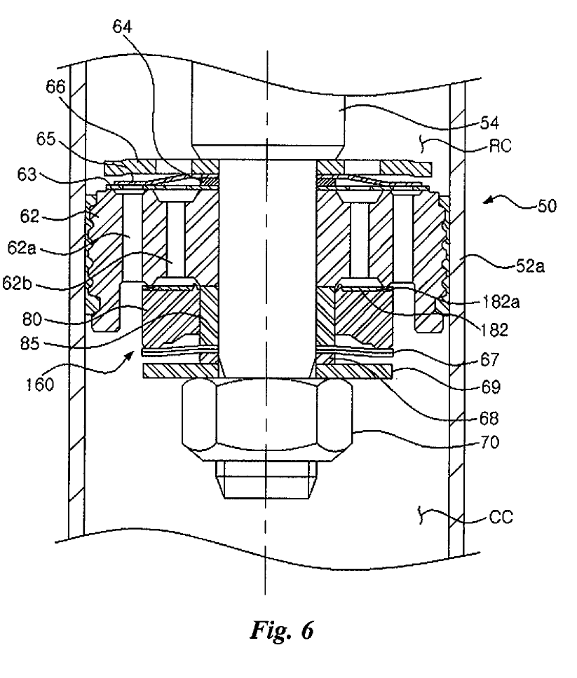

For example, although the slit 82 is directly formed on the upper side of the sliding valve 80 in the above embodiment, a valve apparatus 160 according to another embodiment may include a slit disc 182 as shown in FIG. 6, instead of forming the slit on the upper side of the sliding valve 80.

Referring to FIG. 6, which is a cross-sectional view of the valve apparatus according to another embodiment, the sliding disc 182 is located on the upper side of the sliding valve 80, and is formed with at least one slit 182a which allows a fluid to flow between the rebound passages 62b and the compression chamber CC.

The slit disc 182 allows a fluid passing through the rebound chamber 62b to flow into the compression chamber CC through the slit 182a thereof during the rebound stroke, and, particularly, allows the fluid to generate a low speed damping force when passing through the slit 182a when driving at low speed.

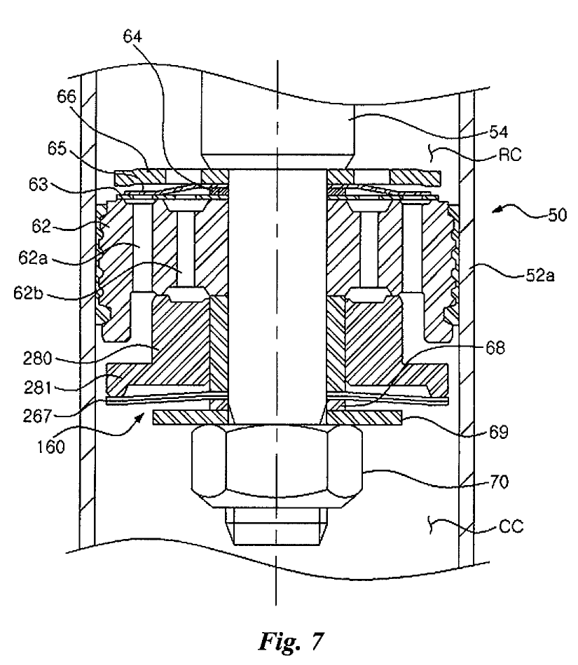

FIG. 7 is a cross-sectional view of a valve apparatus of a shock absorber according to a further embodiment. Referring to FIG. 7, in a valve apparatus 260 according to this embodiment, a sliding valve 280 may have an increased lower outer diameter in order to increase an outer diameter of a valve disc 267.

A lower side of the sliding valve 280 extends outside the piston valve 62 and is formed toward an end thereof with a stepped portion 281 which has a gradually increasing outer diameter. Therefore, the stepped portion 281 of the sliding valve 280 does not block the compression passages 62a, so that the outer diameter of the valve disc 267 can be increased.

As such, when the valve disc 267 has an increased outer diameter, the damping force characteristics can be more smoothly controlled at high speeds. Further, the shape, size and number of the valve discs 267 can be more freely adjusted to control the damping force characteristics.

As apparent from the above description, the valve apparatus of the shock absorber according to embodiments of this invention includes a valve disc which controls an opening degree of rebound passages and has an increased size, thereby permitting easy control of a damping force at low speed and a gradual increase of the damping force even at high speed while obtaining a size decrease of the shock absorber. Further, the valve apparatus of the shock absorber according to embodiments of this invention includes a sliding valve which controls an opening degree of rebound passages and has an increased outer diameter at a lower side thereof, so that the size of the valve disc resiliently supporting the sliding valve can be increased, thereby achieving gradual increase and decrease of damping force between high speed areas.

Although some exemplary embodiments have been described herein, it will be apparent to those skilled in the art that the embodiments are given by way of illustration, and that various modifications and changes can be made without departing from the spirit and scope of the present invention. Accordingly, the scope of the present invention should be limited only by the accompanying claims and equivalents thereof.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A valve apparatus of a shock absorber provided to a piston rod of the shock absorber to generate a damping force by controlling a fluid flow between a rebound chamber and a compression chamber, the valve apparatus comprising:
a piston valve having rebound passages and compression passages allowing a fluid flow between the rebound chamber and the compression chamber;
a sliding valve movably coupled to the piston rod under the piston valve and configured to block the rebound passages; and
at least one valve disc positioned adjacent a lower side of the sliding valve and separated a predetermined distance from a washer by a retainer, the washer being coupled to a lower side of the retainer, the valve disc being capable of bending while resiliently supporting an outer periphery of the sliding valve.

2. The valve apparatus according to claim 1 wherein the sliding valve includes an upper side having at least one slit allowing the fluid flow between the rebound passages and the compression chamber.

3. The valve apparatus according to claim 1, further comprising:
a slit disc disposed adjacent the upper side of the sliding valve and having a slit formed on a circumference of the slit disc to allow the fluid flow between the rebound passages and the compression chamber.

4. The valve apparatus according to claim 1 wherein a lower side of the sliding valve extends beyond the piston valve and is formed at an end thereof with a stepped portion having a gradually increasing outer diameter.

5. The valve apparatus according to claim 1, further comprising:
a guide bush interposed between the sliding valve and the piston rod to guide upward and downward movement of the sliding valve.
